(19) United States
(12) Patent Application Publication
(10) Pub. No.: US 2025/0117204 A1
(43) Pub. Date: Apr. 10, 2025

(54) TRACKING AND EVALUATING INSTALLATION PATTERNS OF APPLICATIONS

(71) Applicant: Playtika LTD, Herzeliya (IL)

(72) Inventors: Moshe SALHOV, Herzeliya (IL); Dan HALBERSBERG, Ramat HaSharon (IL)

(73) Assignee: Playtika LTD, Herzeliya (IL)

(21) Appl. No.: 18/906,208

(22) Filed: Oct. 4, 2024

Related U.S. Application Data
(60) Provisional application No. 63/542,542, filed on Oct. 5, 2023.

(51) Int. Cl. G06F 8/61

(52) U.S. Cl. CPC G06F 8/61

(57) ABSTRACT

A method of improving detection of installation types of applications, comprising receiving an exposure temporal pattern reflecting exposure of one or more application distribution activities launched to promote installation of one or more applications, determining a total installs temporal pattern reflecting all installs of the application(s), determining a direct installs temporal pattern reflecting direct installs of the application(s) resulting from direct exposure to the application distribution activity(s), deriving an unrelated installs level reflecting installs of the application(s) unrelated to the application distribution activity(s), computing, based on the total installs temporal pattern, the direct installs temporal pattern, and the unrelated installs level, a consequent installs temporal pattern reflecting with increased accuracy consequent installs of the application(s) which consequently follow-up on the direct installs, and transmitting the consequent installs temporal pattern to distribution system(s) adapted to adjust one or more application distribution activities according to the increased accuracy consequent installs temporal pattern.

### RELATED APPLICATION(S)

This application claims the benefit of priority under 35 USC § 119 (e) of U.S. Provisional Patent Application No. 63/542,542 filed on Oct. 5, 2023, the contents of which are all incorporated by reference as if fully set forth herein in their entirety.

### BACKGROUND

The present invention, in some embodiments thereof, relates to tracking and evaluating installation patterns of applications and, more specifically, but not exclusively, to tracking installation patterns of applications to evaluate impact of application promotion activities.

The daily routine of people in these moderns times heavily revolves around the use of applications executed by their client devices (e.g., computer, Smartphone, tablet, wearable device, etc.) for practically any aspect of life.

These applications, for example, an application, a mobile application, a web application, an online application, a game, and/or the like may target endless needs, goals, and/or desires ranging from work aid applications, health and lifestyle monitoring applications, thorough travel, shopping, and social networking applications to leisure time application such as, for example, content and media streaming, sports, music, and/or the like to mention just a few.

Major efforts and resources are invested in attempt to expand users base and distribution of applications, among which application distribution activities such as, for example, marketing campaigns, promotion actions, activities and events, advertisement efforts, and/or the like is widely used to promote install (installation) and use of such applications.

### SUMMARY

According to a first aspect of the present invention there is provided a method of improving detection of installation types of applications, comprising using an install evaluation system adapted for:
Receiving an exposure temporal pattern reflecting exposure of one or more application distribution activities launched over a certain time period to promote installation of one or more applications.
Determining a total installs temporal pattern reflecting a total number associated with all installs of the one or more applications over the certain time period.
Determining a direct installs temporal pattern reflecting a number associated with direct installs of the one or more applications resulting from direct exposure to the one or more application distribution activities over the certain time period.
Deriving an unrelated installs level reflecting a number associated with installs of the one or more application which are unrelated to the one or more application distribution activities.
Computing, based on the total installs temporal pattern, the direct installs temporal pattern, and the unrelated installs level, a consequent installs temporal pattern reflecting with increased accuracy a number associated with consequent installs of the one or more applications which consequently follow-up on the direct installs over the certain time period.
Transmitting the consequent installs temporal pattern to one or more distribution systems adapted to adjust one or more application distribution activities according to the increased accuracy consequent installs temporal pattern.

According to a first aspect of the present invention there is provided a system for improving detection of installation types of applications, comprising an install evaluation system adapted to execute a code. The code comprising:
Program instructions to receive an exposure temporal pattern reflecting exposure of one or more application distribution activities launched over a certain time period to promote installation of one or more applications.
Program instructions to determine a total installs temporal pattern reflecting a total number associated with all installs of the one or more applications over the certain time period.
Program instructions to determine a direct installs temporal pattern reflecting a number associated with direct installs of the one or more applications resulting from direct exposure to the one or more application distribution activities over the certain time period.
Program instructions to derive an unrelated installs level reflecting a number associated with installs of the one or more applications which are unrelated to the one or more application distribution activities.
Program instructions to compute, based on the total installs temporal pattern, the direct installs temporal pattern and the unrelated installs level, a consequent installs temporal pattern reflecting with increased accuracy a number associated with consequent installs of the one or more applications which consequently follow-up on the direct installs over the certain time period.
Program instructions to transmit the consequent installs temporal pattern to one or more distribution systems adapted to adjust one or more application distribution activities according to the increased accuracy consequent installs temporal pattern.

According to a first aspect of the present invention there is provided a computer program product of improving detection of installation types of applications, comprising a non-transitory medium storing thereon computer program instructions which, when executed by one or more hardware processors, cause the one or more hardware processors to:
Receive an exposure temporal pattern reflecting exposure of one or more application distribution activities launched over a certain time period to promote installation of one or more applications.
Determine a total installs temporal pattern reflecting a total number associated with all installs of the one or more applications over the certain time period.
Determine a direct installs temporal pattern reflecting a number of direct installs associated with the one or more applications resulting from direct exposure to the one or more application distribution activities over the certain time period.
Derive an unrelated installs level reflecting a number associated with installs of the one or more applications which are unrelated to the one or more application distribution activities.
Compute, based on the total installs temporal pattern, the direct installs temporal pattern and the unrelated installs level, a consequent installs temporal pattern reflecting with increased accuracy a number associated with consequent installs of the one or more applications which consequently follow-up on the direct installs over the certain time period.
Transmit the consequent installs temporal pattern to one or more distribution system adapted to adjust the one or more application distribution activities according to the increased accuracy consequent installs temporal pattern.

In a further implementation form of the first, second and/or third aspects, the number associated with direct installs is determined based on a number associated with direct installs of the one or more applications as result of respective users exposed to content published as part of the one or more application distribution activities.

In a further implementation form of the first, second and/or third aspects, the total number associated with all installs is determined based on all installs reported by a vendor of the one or more applications.

In a further implementation form of the first, second and/or third aspects, the unrelated installs level expresses an averaged level of installs of the one or more applications over the certain time period which are independent of the exposure temporal pattern.

In a further implementation form of the first, second and/or third aspects, the number associated with consequent installs expresses a number associated with installs of the one or more applications by users influenced by other users who made the direct installs.

In a further implementation form of the first, second and/or third aspects, the exposure of one or more application distribution activities relates to expenditure invested in the one or more application distribution activities.

In a further implementation form of the first, second and/or third aspects, the exposure temporal pattern reflects a plurality of expenditure levels over the certain time period.

In a further implementation form of the first, second and/or third aspects, the plurality of expenditure levels are selected according to a random and/or pseudo-random pattern.

In a further implementation form of the first, second and/or third aspects, the plurality of expenditure levels are selected according to sinusoidal pattern having a certain frequency.

In a further implementation form of the first, second and/or third aspects, a time period of each expenditure level is selected from a range of one day to one week.

In a further implementation form of the first, second and/or third aspects, a number of the expenditure levels is selected from a range of five to fifteen.

In a further implementation form of the first, second and/or third aspects, the exposure temporal pattern is selected from a plurality of exposure temporal patterns according to one or more parameters of the one or more application distribution activities.

In an optional implementation form of the first, second and/or third aspects, the install evaluation system is further adapted for:
Receiving a second exposure temporal pattern reflecting exposure of one or more other application distribution activities launched simultaneously with the one or more application distribution activities over the certain time period to promote the one or more applications.
Determining a second total installs temporal pattern reflecting a total number associated with all installs of the one or more applications over the certain time period.
Determining a second direct installs temporal pattern reflecting a number associated with direct installs of the one or more applications directly resulting from the one or more other application distribution activities over the certain time period.
Computing, based on the second total installs temporal pattern, the second direct installs temporal pattern and the unrelated installs level, a second consequent installs temporal pattern reflecting a number associated with consequent installs of the one or more applications which consequently follow-up on the direct installs relating to the one or more other application distribution activities over the certain time period.
Transmitting the second consequent installs temporal pattern to the one or more distribution systems adapted to adjust one or more other application distribution activities according to the increased accuracy second consequent installs temporal pattern.

In a further implementation form of the first, second and/or third aspects, the exposure temporal pattern and the second exposure temporal pattern are orthogonal to each other.

In a further implementation form of the first, second and/or third aspects, the direct installs temporal pattern is computed based on an actual number of the direct installs, the total installs temporal pattern is computed based on an actual number of the total installs, and the consequent installs temporal pattern is computed based on an actual number of the consequent installs.

In a further implementation form of the first, second and/or third aspects, the direct installs temporal pattern is computed based on a revenue associated with the direct installs, the total installs temporal pattern is computed based on a revenue associated with the total installs, and the consequent installs temporal pattern is computed based on a revenue associated with the consequent installs.

In a further implementation form of the first, second and/or third aspects, each of the installs relates to installation of the one or more applications in a client device used by a respective user.

In a further implementation form of the first, second and/or third aspects, each of the one or more applications is a member of a group comprising a game, and a mobile application.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks automatically. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of methods and/or systems as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars are shown by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of an exemplary process of tracking and evaluating installation patterns of applications, according to some embodiments of the present invention;

FIG. 2 is a schematic illustration of an exemplary system for tracking and evaluating installation patterns of applications, according to some embodiments of the present invention; and

FIG. 3A and FIG. 3B are graph charts of exemplary installation patterns of an exemplary application evaluated with respect to application promotion temporal patters, according to some embodiments of the present invention.

### DETAILED DESCRIPTION

The present invention, in some embodiments thereof, relates to tracking and evaluating installation patterns of applications and, more specifically, but not exclusively, to tracking installation patterns of applications to evaluate impact of application promotion activities.

Launching application distribution activities, for example, a marketing campaign, a promotion action, activity and/or event, an advertisement effort, and/or the like to promote install (installation) and use of applications, for example, an application, a mobile application, a web application, an online application, a game, and/or the like is common practice and widely used.

However, accurately tracking and quantifying installs of the application by users in their client devices (e.g., desktop, laptop, Smartphone, tablet, etc.), specifically in relation to impact, effect, motivation, and/or the like induced by application distribution activities may be highly challenging.

While numbers, and/or patterns relating to some install types of the applications by users may be relatively easy, simple, and/or straight forward to obtain and/or determine, tracking and accurately identifying other types of installs of applications may be highly challenging.

For example, a number associated with total installs reflecting all installs of a certain application over a certain time period, during which one or more application distribution activities promoting the certain application are active, may be relatively easy to obtain from one or more sources, for example, a vendor of the application, an application store (e.g., Apple Store, google Play, etc.), an application repository, an application download website, and/or the like.

In another example, a number associated with direct installs resulting from direct exposure of users to the application distribution activity(s), specifically to content published, and/or served as part of the application distribution activity(s) may be also relatively simple to obtain. The number(s) associated with these direct installs may be received from one or more systems, services, and/or platforms configured to detect direct installs, for example, track user activation (click, selection, etc.) of ADs posted as part of application distribution activities in online resources, detect direct installs by activating links embedded in massages directly targeting users (e.g., email, text message, SMS, etc.), and/or the like.

In contrast, identifying a number of unrelated installs which are unrelated and independent of application distribution activities promoting the application, i.e., installs of the certain application regardless of whether or not an application distribution activities are currently active or not, may present a major challenge.

It may also be highly difficult to accurately track and determine a number of consequent installs which follow-up on direct installs. Such consequent installs may not directly result from exposure of users to content of application distribution activities but rather from one or more follow-up events, flows, conditions, and/or the like. Such follow-up activity may lead users to install the application even if they were not directly exposed to the (content of) application distribution activity(s) launched to promote the application. Rather than due to direct exposure, such consequent installs may be traced, for example, to one or more viral sensations relating to the application(s) which may widely and rapidly spread over the network (internet) and may thus lead users to install the application. In another example, consequent installs may be traced to exposure to one or more celebrities, network influencers, and/or the like who installed the application and may motivate other users to also do so.

Moreover, when multiple application distribution activities are simultaneously active in parallel, it may be significantly difficult to accurately determine which consequent install may be attributed to each application distribution activity.

According to some embodiments of the present invention, there are provided methods, systems and computer program products for tracking and evaluating installation patterns of applications by users in client devices, in particular, for accurately tracking and computing consequent installs patterns reflecting installs of applications which consequently follow-up on direct installs of the application.

An exposure temporal pattern received, determined, and/or computed for each application distribution activity may define and/or reflect an estimated exposure of uses to the respective application distribution activity over a time period while the respective application distribution activity is active, specifically exposure to content published, introduced, served, and/or promoted as part of the respective application distribution activity. The exposure temporal pattern which may reflect the exposure per time unit (e.g., hour, day, week, etc.) during the active time period may be determined, for example, based on expenditure spent as part of the respective application distribution activity per time unit, based on an estimated number of users exposed to the respective application distribution activity, and/or the like.

A total installs temporal pattern may be determined and/or computed, based on a total installs number associated with all installs of the application, to reflect the total installs of the application per time unit during the active time period.

A direct installs temporal pattern may be also determined and/or computed, based on a number associated with the direct installs of the application, to reflect the direct installs of the application per time unit during the active time period.

In addition, an unrelated installs level may be derived, determined, and/or computed to reflect a number associated with installs that are unrelated, i.e., independent, and/or unaffected by any application distribution activity. For example, the unrelated installs level may be computed, estimated, and/or determined based on the total number of installs during one or more time units during which little, insignificant or even no content is published as part of the application distribution activity(s) such that exposure of users to content published as part of the application distribution activity(s) may be negligible.

Optionally, the unrelated installs level determined for multiple time periods may be aggregated to produce an aggregated, for example, averaged unrelated installs level. In another example, the unrelated installs level may be computed, estimated, and/or determined based on the total number of installs during one or more time units outside the active time period, i.e., no application distribution activities are active.

A consequent installs temporal pattern, reflecting the consequent installs per time unit during the active time period, may be then computed based on the total, unrelated and direct installs, for example, by subtracting the numbers associated with the unrelated and direct installs from the number associated with the total installs.

Moreover, installs of one or more applications may be accurately tracked while a plurality of application distribution activities are launched and/or active simultaneously to promote installation and use of the respective application, and specifically to accurately trace each consequent install to a respective one of the multiple application distribution activities. This may be achieved, for example, by applying to the multiple application distribution activities respective exposure temporal patterns which are orthogonal to each other such that they are unrelated, and/or weakly related in terms of their content publishing timing, schedule, geographical area, and/or the like. Consequent installs relating to each of the application distribution activities may be therefore accurately computed and/or determined.

Tracking and computing the number associated with the consequent installs of applications in relation to application distribution activities may present major benefits and advantages compared.

First, since the total number of installs of the application is constructed of the number of direct installs, the number of unrelated installs and the number consequent installs, the consequent installs temporal pattern computed based on this formulation may be highly accurate and may therefore reflect with increased accuracy the consequent installs per time unit during the application distribution activity. Tracing the consequent installs to application distribution activities with increased accuracy may significantly improve segmentation and/or differentiation of the different install types of each of one or more applications in general and per time unit (e.g., hour, day, week, etc.) in particular.

Moreover, analysis of the accurately determined number of installs during application distribution activities in general and per time period in particular may reveal and/or identify trends, phenomenon, relations, and/or correlations between installs patterns and the exposure temporal pattern. This analysis may further expose relations, and/or correlations between the installs types themselves, for example, correlation between direct installs and accurately computed consequent installs. One or more application distribution activities may be therefore adjusted according to these identified trends, phenomenon, relations, and/or correlations and/or in attempt to increase performance of the application distribution activities.

Furthermore, analyzing the accurately determined number of installs during one or more application distribution activities may allow for accurately computing a K-Factor for the respective application distribution activity which may reflect vitality of distributed application. The K-Factor may therefore reveal effectivity of the application distribution activities to identify which of them is more effective. For example, assuming two marketing campaigns cost the same and are identified to induce the same number of direct installs. While the two campaigns may appear similar, assuming the K-Factor of the first campaign is five and the K-Factor of the second campaign is two, obviously the first campaign may be more efficient than the second campaign since it leads to more installs and possibly to increased revenues for the same investment.

Based on insights, observations, and/or assumptions resulting from the analysis, one or more parameters, characteristics, and/or attributes of one or more application distribution activities may be adjusted to increase their performance, effectivity, and/or robustness, for example, increase number of installs (direct and/or consequent) of the promoted applications, increase visibility and/or exposure, improve penetration into one or more market segments, improve traction one or more market segments, reduce cost, and/or the like. For example, content publishing channels (e.g., digital advertising, outdoor advertising, promotion events, direct targeting of users, etc.) used for one or more application distribution activities may be selected according to publishing channel effectivity learned from analysis of the installs patterns. In another example, scheduling and/or timing of content publishing may be adjusted for one or more application distribution activities according to scheduling and/or timing identified to increase exposure and install numbers based on analysis of the installs temporal patterns.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer program code comprising computer readable program instructions embodied on a computer readable medium may be transmitted using any appropriate medium, including but not limited to wireless, wire line, optical fiber cable, RF, etc., or any suitable combination of the foregoing.

The computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The computer readable program instructions for carrying out operations of the present invention may be written in any combination of one or more programming languages, such as, for example, assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Python, Java, Scala, Smalltalk, C++ or the like, and conventional procedural programming languages, such as the “C” programming language or similar programming languages including and not limited to statistical languages such as, for example, R, MATLAB, SPSS, Statistica, SAS/JMP, and/or the like.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

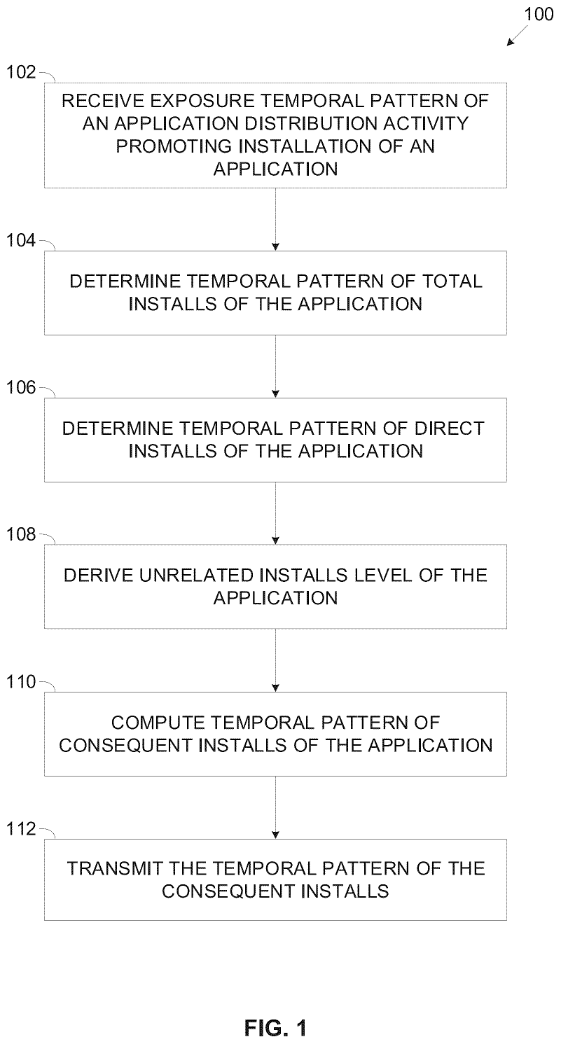

Referring now to the drawings, FIG. 1 is a flowchart of an exemplary process of tracking and evaluating installation patterns of applications, according to some embodiments of the present invention.

An exemplary process 100 may be executed to track installs (installations) of one or more applications by users, specifically in relation to one or more application distribution activities launched to promote installation of the applications, for example, a marketing campaign, a promotion action, an advertisement effort, and/or the like in order to provide insights on impact of exposure to the distribution activities on users inclination to install the applications.

In particular, the process 100 may be executed to track and evaluate consequent installs which may reflect installs of an application which consequently follow-up on direct installs of the application traced to direct exposure to the application distribution activity(s) and may often be paid installs. In other words, the consequent installs may be viral installs which may be traced to impact of users, activities, and/or events relating to the direct installs which in turn can be directly traced to exposure to content published as part of the application distribution activity(s).

The tracking and evaluation the consequent installs may be computed based on a total number of installs of the application and the number of direct installs, which may be both tracked by one or more distribution, sell, marketing, and/or vending, systems, services, and/or platforms. Moreover, the number of consequent installs may be further computed based on a level of unrelated installs which reflect installs of the application independently of any application distribution, marketing, advertisement, and/or promotion, activities.

A number associated with the consequent installs of the application may be provided, transmitted and/or otherwise delivered to one or more distribution, marketing, advertisement, and/or promotion systems which may adjust, adapt, and/or change one or more distribution, marketing, advertisement, and/or promotion, activities accordingly in attempt to improve distribution of the applications and increase its installs by users.

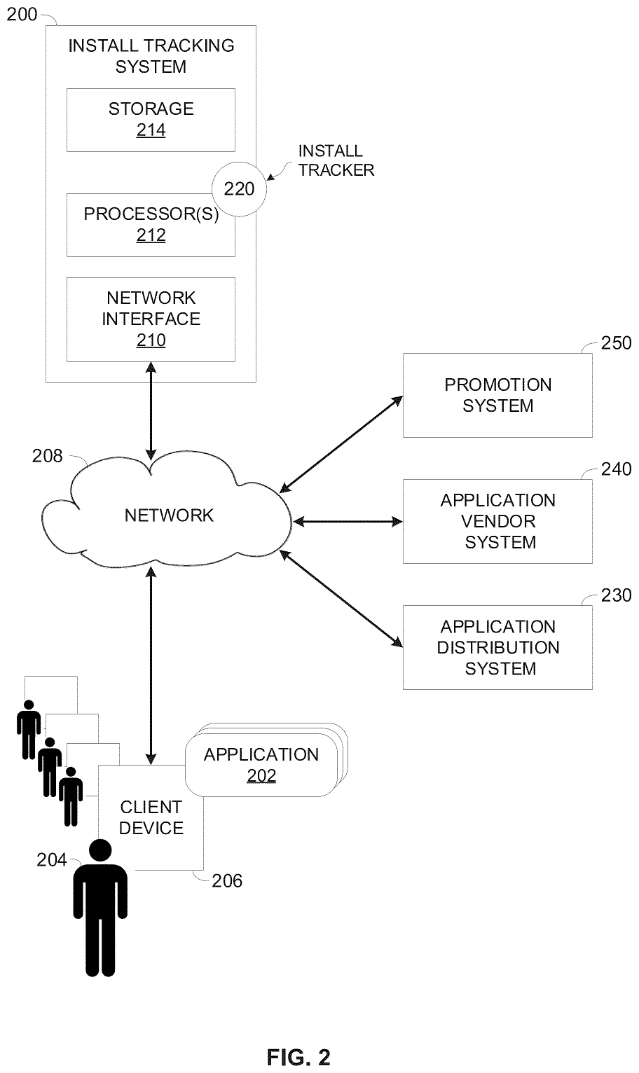

Reference is also made to FIG. 2, which is a schematic illustration of an exemplary system for tracking and evaluating install (installation) patterns of applications, according to some embodiments of the present invention.

An install tracking system 200 adapted to execute the process 100 may be deployed to track and evaluate installs (installations) of one or more applications 202 in client devices 206 used by one or more users 204, for example, a desktop computer, a laptop computer, a Smartphone, a tablet, a proprietary client device and/or the like which may execute the installed application(s) 202.

The application(s) 202, for example, an application, a mobile application, a web application, an online application, a game, and/or the like may be typically installed by downloading the respective application 202 to the client devices 206 for install via a network 208 comprising one or more wired and/or wireless networks, for example, a Local Area Network (LAN), a Wireless LAN (WLAN, e.g. Wi-Fi), a Wide Area Network (WAN), a Metropolitan Area Network (MAN), a cellular network, the internet and/or the like.

Via the network 208, each of one or more of the users 204 using his associated client device 206 may access one or more networked systems, services, and/or platforms to download one or more applications 202 and install them on the client device 206. For example, one or more client devices 206 may communicate, over the network 208, with one or more application distribution systems 230, for example, an online store (e.g., Apple Store, Google Play, etc.), a public domain website, an applications repository, and/or the like to download and install one or more applications 202. In another example, one or more client devices 206 may communicate, over the network 208, with one or more application vendor systems 240, for example, a website of the application's vendor, a release server, a download portal, and/or the like to download and install one or more applications 202.

The application(s) 202 may comprise practically any application type, market, segment, use, and/or the like, for example, games, social media applications, news and media streaming applications, online shopping applications, dating applications, financial applications, office tools, travel, navigation and/or transportation applications, automotive related applications, leisure time applications (e.g., reading, fitness, physical training, mental training, music lessons, food and cooking, etc.), and/or the like.

The install tracking system 200, for example, a server, a computing node, a cluster of computing nodes, and/or the like may include a network interface 210 for connecting to the network 208, a processor(s) 212 for executing the process 100, and a storage 214 for storing data and/or code (program store).

The network interface 210 may comprise one or more wired and/or wireless network adapters, implemented via hardware, software, and/or a combination thereof, for connecting to the network 208. Via the network 208 the install tracking system 200 may communicate with one or more networked resources, for example, the application distribution system(s) 230, the application vendor system(s) 240, and/or the like. In another example, the evaluation system 200 may communicate, via the network 208, with one or more promotion systems 250, for example, an advertisement management server, a campaign management service, a promotion service, and/or the like adapted to launch, monitor, manage and/or control one or more application distribution activities, for example, a marketing campaign, a promotion action, an advertisement effort, and/or the like launched to promote installation of one or more applications 202.

The processor(s) 212, homogenous or heterogeneous, may include one or more processing nodes and/or cores arranged for parallel processing, as clusters and/or as one or more multi core processor(s).

The storage 214 may include one or more non-transitory persistent storage devices, for example, a Read Only Memory (ROM), a Flash array, a Solid State Drive (SSD), a hard drive (HDD) and/or the like. The storage 214 may also include one or more volatile devices, for example, a Random Access Memory (RAM) component, a cache and/or the like. Optionally, the storage 214 may further include one or more network storage devices accessible via the network interface 210, for example, a Network Attached Storage (NAS), a storage server, and/or the like.

The processor(s) 212 may execute one or more software modules such as, for example, a process, a script, an application, an agent, a utility, a tool, an Operating System (OS) and/or the like each comprising a plurality of program instructions stored in a non-transitory medium (program store) such as the storage 214 and executed by one or more processors such as the processor(s) 212.

Optionally, the processor(s) 212 may include one or more hardware elements available by the install tracking system 200, for example, a circuit, a component, an Integrated Circuit (IC), an Application Specific Integrated Circuit (ASIC), a Field Programmable Gate Array (FPGA), a Digital Signals Processor (DSP), a Graphic Processing Unit (GPU), and/or the like.

The processor(s) 212 may therefore execute one or more functional modules utilized by one or more software modules, one or more of the hardware elements and/or a combination thereof. For example, the processor(s) 212 may execute an install tracker 220 adapted to execute the process 100 for tracking and evaluating installs of one or more applications 202 by users 204 using their respective client devices 206 to install and execute the application(s) 202.

Optionally, the install tracking system 200, specifically the install tracker 220 may be provided, executed and/or utilized by one or more cloud computing services, platforms, and/or infrastructures, for example, Infrastructure as a Service (IaaS), Platform as a Service (PaaS), Software as a Service (SaaS), and/or the like such as, for example, Google Cloud™, Microsoft Azure®, Amazon Web Service® (AWS) and Elastic Compute Cloud® (EC2), IBM Cloud®, and/or the like.

For brevity, the processes 100 is described for tracking and evaluating installs of a single application 202. This, however, should not be construed as limiting since, as may become apparent to a person skilled in the art, the process 100 may be duplicated, expanded, and/or scaled for tracking and evaluating installs of a plurality of applications 202.

As shown at 102, the install tracker 220 may receive an exposure temporal pattern reflecting exposure of one or more application distribution activities launched over a certain time period to promote installation, and use, of an application 202, for example, a mobile application, a web application, an online application, a game, and/or the like.

Each application distribution activity, for example, a marketing campaign, a promotion action, an advertisement effort, and/or the like may be launched and managed over a certain time period, for example, a week, a month, a year, and/or the like.

During the time period defined for each application distribution activity, one or more actions, operations, activities, events, and/or the like, collectively designated promotion actions herein after, may be conducted in order to expose the application 202 to a plurality of users such as the user 204 and promote its installation by the users 204.

For example, one or more application distribution activities may comprise posting one or more advertisements (ADs) to promote the application 202, for example, a print AD (e.g., newspaper, brochure, etc.), digital media AD (e.g., website, search engine, banner, pop-up, social media, etc.), an in-game AD, a broadcast AD (e.g., television, radio, cinema, online media streaming, podcasts, etc.), a personalized ADs (e.g., text message, email, mail, etc.), an outdoor AD (e.g., billboard, poster, transit AD, etc.), and/or the like.

In another example, one or more application distribution activities may comprise hosting and/or sponsoring one or more events to gain visibility and exposure to the application 202, for example, a gathering, a sports game, an entertainment show a music festival, and/or the like in which marketing means, for example, advertisement content, merchandise, promotion personnel, and/or the like may be deployed to attract attention of visitors attending the event.

In another example, one or more application distribution activities may comprise direct contacting users such as the users 204 who may be potentially interested in using the application 202 via one or more communication channels in attempt to interest these users in the application 202. Such communication channels may include, for example, telemarketing, direct text messages (e.g., SMS, WhatsApp, etc.), direct emails, and/or the like.

The exposure of each of one or more application distribution activities may be measured, estimated, and/or predicted using one or more methods, techniques, and/or metrics. For example, the exposure of one or more application distribution activities may relate to expenditure invested in the respective application distribution activity, i.e., cost of the promotion actions conducted as part of the respective application distribution activity, for example, cost of promotion ADs, cost of resources invested in the promotion activity(s), and/or the like. In another example, the exposure of one or more application distribution activities may relate to an estimated number of users 204 who were exposed to the promotion effort through the promotion actions conducted as part of the respective application distribution activity, for example, a number of users 204 who were exposed to promotion ADs, a number of users 204 who participated in a promotion event, and/or the like.

In particular, since the promotion actions, activates, events, and/or the like conducted as part of each application distribution activity may be spread over the certain time period defined for the respective application distribution activity, the exposure of the application distribution activity may be defined, expressed, and/or illustrated by an exposure temporal pattern (time series) reflecting exposure of the respective application distribution activity during the certain time period defined for the respective application distribution activity.

The exposure temporal pattern of each application distribution activity may therefore reflect the exposure, for example expenditure, estimated number of exposed users, and/or the like of the respective application distribution activity per time unit, for example, per hour, per day, per week, and/or the like. Optionally, the duration of the time units may be selected for one or more application distribution activities from one or more ranges, for example, a range of one day to one week with one day granularity, a range of 6 to 72 hours with a 3 hours granularity, and/or the like.

For example, the exposure temporal pattern of each application distribution activity may reflect a plurality of expenditure levels (values) over the certain time period defined for the respective application distribution activity. As such, a certain expenditure level may be defined per each time unit during the certain time period of the respective application distribution activity. The time period of each expenditure level may therefore correspond to the time units defined for the respective application distribution activity.

The number of the expenditure levels may be arbitrary. However, optionally, the number of expenditure levels may be selected from one or more ranges, for example, a range of one to ten, a range of five to fifteen, a range of one to twenty, and/or the like.

Optionally, the expenditure levels defined and spent per time unit during the certain time period of each application distribution activity may be selected randomly according to one or more random and/or pseudo-random patterns. The random and/or pseudo-random patterns may be generated using one or more random and/or pseudo-random number generators.

Optionally, the expenditure levels defined and spent per time unit during the certain time period of each application distribution activity may be selected according to one or more sinusoidal pattern having one or more frequencies. The sinusoidal patterns may be generated using one or more elementary sinus functions, modules, and/or the like utilized through software, hardware, and/or a combination thereof. Moreover, the frequency of one or more of the sinusoidal pattern may be selected randomly according to one or more random and/or pseudo-random patterns.

Optionally, the exposure temporal pattern of one or more application distribution activity may be selected from a plurality of exposure temporal patterns according to one or more parameters of the respective application distribution activity. For example, a first application distribution activity may be launched for fast and aggressive marketing campaign of a trendy product and/or service. In such case, a short term exposure temporal pattern may be selected for the first application distribution activity where the certain time period may be significantly short, for example, three days segmented to short time units, for example, four hours with significantly high expenditure levels allocated per each time unit. In another example, a second application distribution activity may be launched for branding a certain product and/or service. In such case, a long term exposure temporal pattern may be selected for the second application distribution activity where the certain time period may be significantly long, for example, six months segmented to relatively long time units, for example, two weeks with relatively low expenditure levels allocated per each time unit.

Obviously, the duration of each application distribution activity, the selected expenditure levels and the distribution of expenditure levels over the time units defined for the respective application distribution activity may be limited by an overall budget allocated for the respective application distribution activity such that the overall expenditure level, i.e., the cumulative value of expenditures, during the entire certain time period of the respective application distribution activity does not exceed the overall budget.

The exposure temporal pattern of each application distribution activity (e.g., campaign, promotion, advertisement, etc.) including the certain time period, the time units and/or the expenditure levels of the respective application distribution activity may be defined automatically, manually, and/or in a combination thereof by one or more users and/or systems adapted to define and configure the respective application distribution activity, for example, campaign manager, coordinator, advertiser, and/or the like. Optionally, the expenditure levels may be selected, and/or defined by the install tracker 220 and/or according to instructions generated by the install tracker 220.

As shown at 104, the install tracker 220 may determine and/or compute a temporal pattern of total installs which may reflect a total number associated with all installs of the application 202 over the certain time period of one or more application distribution activities where each install (installation) relates to installation of application 202 in a client device 206 used by a respective user 204.

The install tracker 220 may determine the total number associated with all installs of the application 202 based on all installs reported by one or more systems associated with a vendor of the application 202 which may express the total number of installs per time unit over the certain time period defined for an application distribution activity. For example, the install tracker 220 may communicate with one or more of the systems of the vendor of the application 202, i.e., the application vendor system(s) 240, to receive the number associated with all installs of the application 202, in particular the number associated with installs per time unit over the certain time period. In another example, the install tracker 220 may communicate with one or more of the application distribution systems 230 where the application 202 may be downloaded and installed, for example, an applications store (e.g., Apply App Store, Google Play, etc.), a system hosting a download webpage, and/or the like.

The total number associated with all installs of the application 202 may be expressed in one or more metrics, measures, and/or methods. For example, the total number may reflect an actual number of the total installs of the application 202 which may be reported by the vendor of the application 202. This means, that in such case, the install tracker 220 may compute the total install temporal pattern based on the actual total number of installs of the application 202. In another example, assuming installation of the application 202 requires payment, i.e., paid install, the total number may reflect a revenue associated with the total installs of the application 202. This means, that in such case, the install tracker 220 may compute the total install temporal pattern based on the revenue associated with the total installs.

As shown at 106, the install tracker 220 may determine and/or compute a temporal pattern of direct installs which may reflect a number associated with direct installs of the application 202 resulting from direct exposure to one or more application distribution activities over the certain time periods of the application distribution activities.

The number associated with the direct installs may be therefore determined and/or computed based on a number associated with installs of the application 202 reflecting installations of the application 202 by users 204 who were exposed to content published as part of an application distribution activity and as result installed the application 202 on their client device(s) 206.

One or more direct installs may be traced, for example, to exposure of users 204 to advertisement published as part of one or more application distribution activities launched for promoting installation of the application 202. For example, one or more users 204 using their client devices 206 may browse one or more webpages and encounter one or more ADs posted as part of an application distribution activity, for example, a banner AD, a pop-up AD, and/or the like. One or more of the users 204 may select (e.g., click) the AD and may be directed to a download website where they may download and install the application 202 which are thus direct installs directly traced to exposure to the AD. In another example, one or more users 204 may receive one or more direct targeting AD messages transmitted to the users 204 as part of an application distribution activity, for example, an email, a text message, an SMS, and/or the like. One or more of the users 204 may select (e.g., click) a link embedded in the AD messages and may be directed to a download website where they may download and install the application 202 which are thus direct installs directly traced to exposure to the AD.

In another example, one or more direct installs may be traced to exposure to promotion events held as part of one or more application distribution activities launched for promoting installation of the application 202. For example, One or more users 204 may attend a certain promotion event held as part of an application distribution activity where one or more hosts working at the event may introduce the application to the users 204 and convinces them to install the application 202 in their client device(s) 206 which are thus direct installs directly traced to exposure to event host.

The install tracker 220 may determine the number associated with direct installs of the application 202 based on installs reported by one or more systems associated with the vendor of the application 202 which may track the direct installs per time unit over the certain time period defined for an application distribution activity. For example, the install tracker 220 may communicate with one or more of the application vendor systems 240, the application distribution systems 230, and/or the like which may track the direct installs in general and per time unit in particular.

As described herein before for the total installs, the number associated with the direct installs of the application 202 may be expressed in one or more metrics, measures, and/or methods. For example, the number associated with the direct installs may reflect an actual number of the direct installs of the application 202. This means, that in such case, the install tracker 220 may compute the direct install temporal pattern based on the actual number of direct installs of the application 202. In another example, the number associated with the direct installs may reflect a revenue associated with the direct installs of the application 202. This means, that in such case, the install tracker 220 may compute the direct install temporal pattern based on the revenue associated with the direct installs.

As shown at 108, the install tracker 220 may derive and/or compute an unrelated installs level reflecting a number associated with installs of the application 202 which are unrelated to any application distribution activity, i.e., installs which are separate, independent, and/or unaffected from the application distribution activity.

Similarly to the total installs and the direct installs, the number associated with the unrelated installs of the application 202 may be expressed in one or more metrics, measures, and/or methods, for example, an actual number of unrelated installs of the application 202, a revenue associated with the unrelated installs of the application 202, and/or the like.

The install tracker 220 may apply one or more methods, techniques, algorithms, and/or formulations for deriving and/or computing the unrelated installs level.

For example, based on the total installs temporal pattern and the exposure temporal pattern, the install tracker 220 may identify the total number of installs per time unit during one or more time periods while, as identified in the exposure temporal pattern, no application distribution activities are in progress. As such, installs of the application 202 during these time periods may not be attributed to exposure to content published as part of any application distribution activity. Rather such installs may be considered intendent and unaffected by any application distribution activities. The install tracker 220 may therefore determine accordingly the number of unrelated installs during these time periods, and optionally the number of unrelated installs per time unit during these time periods.

In another example, the install tracker 220 may apply one or more extrapolation functions to extract the level of unrelated installs even while one or more application distribution activities are in progress. For example, based on the total installs temporal pattern, the install tracker 220 may analyze total number of installs in each of a plurality of time units during a certain time period while one or more application distribution activities are in progress and may identify one or more installs patterns which are significantly independent of the exposure temporal pattern. For example, a certain level of installs may be identified in a plurality of time units regardless of the exact exposure to content of the application distribution activity(s) during these time units. The install tracker 220 may therefore determine that these installs are unrelated installs which may be independent of the exposure temporal pattern.

The install tracker 220 may further process the number associated with the unrelated installs identified per time unit in order to define a common baseline level.

For example, the install tracker 220 may average the number associated with the unrelated installs such that the unrelated installs level may express an averaged level of installs of the application 202. The averaged unreacted installs level installs may be therefore applied to express the averaged level of unrelated installs during the certain time period of one or more application distribution activities which are independent of the exposure temporal pattern, i.e., are independent and unrelated to content published as part of the application distribution activities.

As shown at 110, the install tracker 220 may compute a consequent installs temporal pattern based on the total installs temporal pattern, the direct installs temporal pattern, and the unrelated installs level.

The consequent installs temporal pattern may reflect a number associated with consequent installs of the application 202 which consequently follow-up on the direct installs of the application 202 over the certain time period of one or more application distribution activities. As such the consequent installs may include only a component (portion) of installs of the application 202 corresponding to the consequent installs and excluding direct, and/or unrelated installs. Consequently the consequent installs temporal pattern may therefore reflect only consequent installs and exclude direct, and/or unrelated installs.

The number associated with the consequent installs may expresses a number associated with installs of the application 202 by users influenced by other users who made the direct installs. This means that rather than installing the application 202 as result of direct exposure to the content published as part of the application distribution activity(s), the consequent installs are done by users 204 who were motivated to install the application 202 after exposed and/or influenced to do so by one or more of the users 204 who made direct installs.

For example, one or more consequent installs may be done by one or more users 204 who were exposed to one or more users 204, for example, a celebrity, a social media influencer, and/or the like who installed (direct install) the application 202 and recommends it to others. In another example, one or more consequent installs may be done by one or more users 204 who were exposed to one or more viral content sensations relating to the application 202, for example, a text, a video clip, an audio clip, and/or the like which is widely and rapidly spread over the network (internet).

As described herein before for other installs, the number associated with the consequent installs of the application 202 may be expressed in one or more metrics, measures, and/or methods, for example, an actual number of consequent installs of the application 202, a revenue associated with the consequent installs of the application 202, and/or the like.

Since the install tracker 220 computes the consequent installs temporal pattern based on the specific individual and accurately determined components of the total installs, namely the direct installs temporal pattern and the unrelated installs level, the consequent installs temporal pattern may be computed with significantly increased accuracy. For example, the install tracker 220 may compute the number associated with the consequent installs of the application 202 per time unit, for example, by subtracting the direct installs and the unrelated installs at the respective time unit from the total installs at the respective time unit. The install tracker 220 may then compute the consequent installs temporal pattern by aggregating the unrelated installs of the application 202 computed per time unit during the certain time period of each application distribution activity launched to promote installation of the application 202. Moreover, since the computations are made per time unit (e.g., day, week, etc.)

during the certain time period of each application distribution activity, the install tracker 220 may accurately compute the number associated with the consequent installs per each time unit. Thus, in conjunction with the exposure temporal pattern, the install tracker 220 may accurately determine a relation between the exposure of content published as part of one or more application distribution activities in each time unit and the respective number associated with consequent installs during the respective time unit. While this relation is indirect, since the consequent installs are not traced to exposure of content published as part of the application distribution activity(s), this relation may indicate, suggest, imply and/or hint as to the indirect impact of the published content on consequent installs through exposure to users 204 who did install the application 202 as result of exposure to the published content.

As shown at 112, the install tracker 220 may transmit the consequent installs temporal pattern computed for the application distribution activity(s) to one or more systems which may be adapted to adjust one or more application distribution activities according to the increased accuracy consequent installs temporal pattern.

For example, the install tracker 220 may transmit the consequent installs temporal pattern via the network 208 to one or more of the distribution system(s) 230, the application vendor system(s) 240, the promotion system(s) 250 and/or the like each utilized, for example, by one or more servers. In another example, the install tracker 220 may transmit, via the network 208, the consequent installs temporal pattern to one or more cloud based distribution services.

The temporal patterns, the total installs temporal pattern, the direct installs temporal pattern, and the increased accuracy consequent installs temporal pattern may be analyzed, for example, by the distribution system(s) 230, the application vendor system(s) 240, and/or the promotion system(s) 250 to identify one or more trends, phenomenon, relations, and/or correlations between the installs patterns and the exposure temporal pattern and further with respect to each other, for example, a correlation between the direct installs and the accurately computed consequent installs.

The distribution system(s) 230, the application vendor system(s) 240, and/or the promotion system(s) 250, for example a campaign management system, an advertisement brokering system, a promotion organizing system, and/or the like may be further adapted to create, and/or adjust one or more application distribution activities according to identified trends, phenomenon, relations, and/or correlations in attempt to increase performance of the application distribution activities.

For example, the identified trends, phenomenon, relations, and/or correlations may yield insights, observations, and/or assumptions which may analyzed, for example, by the distribution system(s) 230, the application vendor system(s) 240, and/or the promotion system(s) 250, and/or the like. Based on this analysis one or more content publishing parameters may be adjusted for one or more application distribution activities, for example, content publishing channels (e.g., digital advertising, outdoor advertising, promotion events, direct targeting of users, etc.), content publishing schedule and/or timing, and/or the like.

Such adjustments to one or more application distribution activities may be done in attempt to increase performance of the adjusted application distribution activities, for example, increase a number of direct installs, increase a number of consequent installs, increase overall number of installs, and/or the like. In another example, adjusting one or more application distribution activities may be done to improve one or more other parameters of the application distribution activities, for example, reduce cost, increase visibility and/or exposure, improve penetration into one or more market segments, improve traction one or more market segments, and/or the like.

For example, assuming that based on analysis of the consequent installs temporal pattern relating to one or more application distribution activities, an exemplary promotion systems 250 determines that intensely publishing promotion content for the application 202 during two consecutive time units, for example, two days in a row, followed by one no publication time unit (e.g. one day) significantly increases consequent installs compared to publishing promotion content during alternating time periods, for example, intensely publish promotion content one day followed by a no publication day. In such case, the promotion systems 250 may adjust accordingly one or more application distribution activities, for example, a marketing campaign, which are currently in progressed and/or planned to be launched in the future, to employ a two consecutive time units of intense content publication followed by one less intense or even no content publication time unit.

In another example, assuming that based on analysis of the consequent installs temporal pattern relating to one or more application distribution activities, the exemplary promotion systems 250 determines that intensely publishing promotion content for the application 202 during over five consecutive time units, for example, five days may invoke a viral sensation relating to the application 202 which leads to an extremely large number of consequent installs. In such case, the promotion systems 250 may adjust accordingly one or more application distribution activities, for example, a marketing campaign, which are currently in progressed and/or planned to be launched in the future, to employ a five consecutive time units period of intense content publication in anticipation to invoke a viral sensation.

It should be noted, that while the analyzed application distribution activity(s) relates to promoting installation of the application 202, the application distribution activities, which may be adjusted by the distribution system(s) 230, the application vendor system(s) 240, and/or the promotion system(s) 250 according to the consequent installs temporal pattern, may be launched either for promoting the application 202 and/or for promoting one or more other applications such as the application 202, for example, another game, another mobile application, and/or the like.

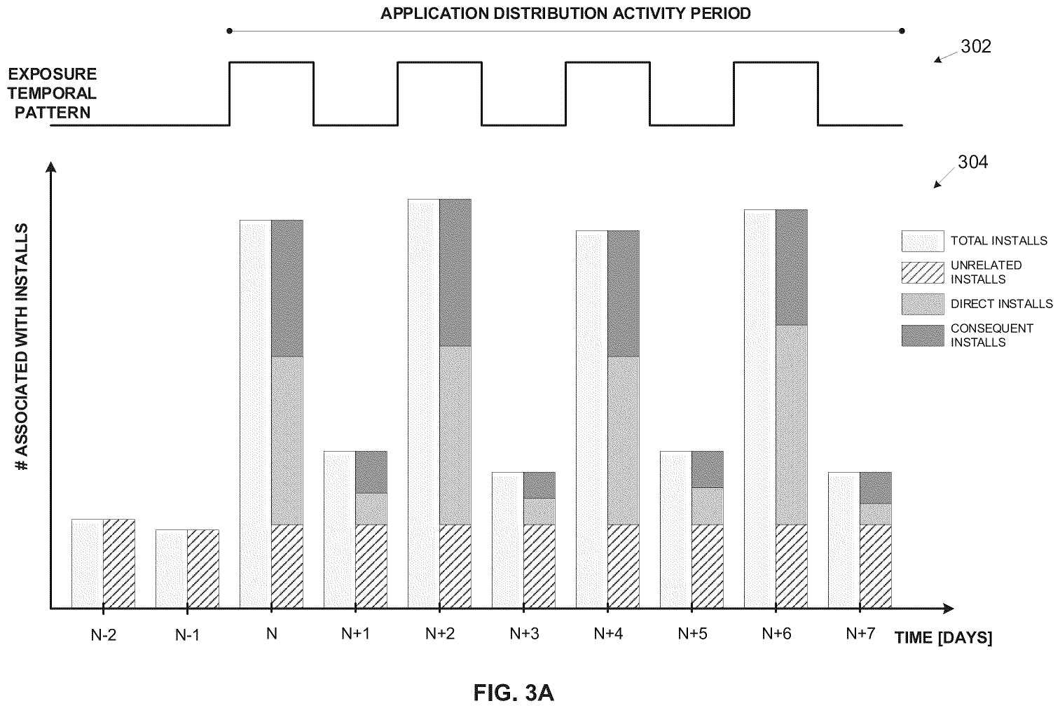

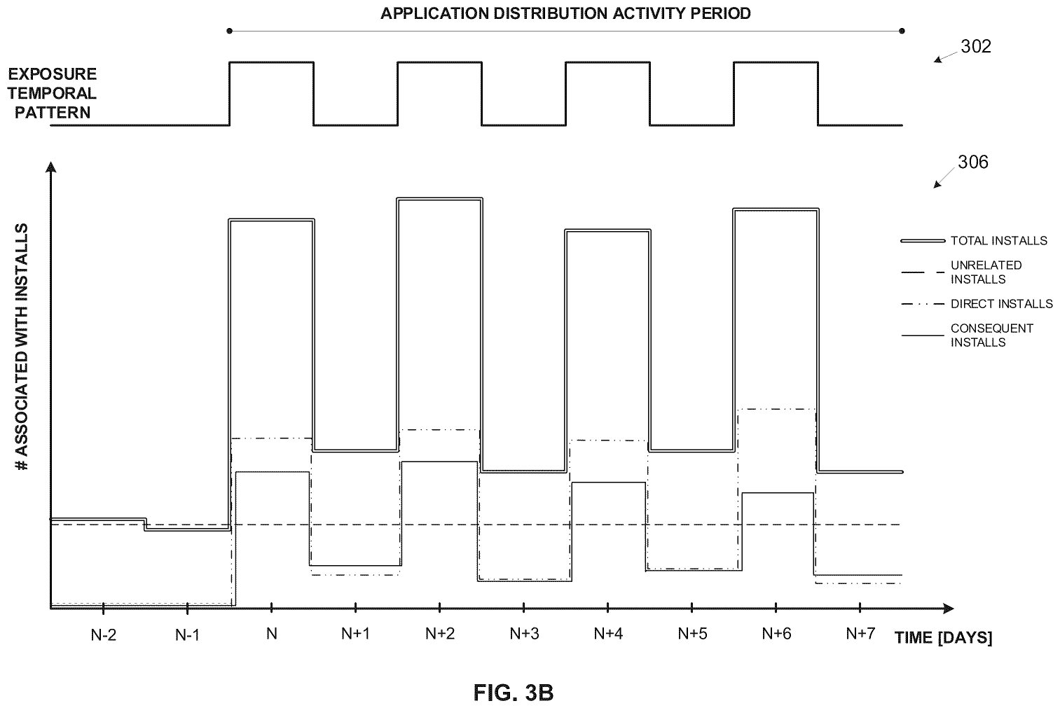

Reference is ow made to FIG. 3A and FIG. 3B, which are graph charts of exemplary installation patterns of an exemplary application evaluated with respect to application promotion temporal patters, according to some embodiments of the present invention.

An exemplary exposure temporal pattern 302 may be applied, selected, and/or defined for an application distribution activity launched to promote installation and use of an application such as the application 202 over a certain time period, for example, eight days segmented to a plurality of time units, for example, days. The application distribution activity launched on day N may be therefore active until day N+7 (inclusive) and may end after that.

A graph chart 304 illustrates a histogram of exemplary numbers of total installs of the application 202 during each time period of the application distribution activity, numbers of unrelated installs of the application 202 which are independent and unrelated to the application distribution activity, numbers of direct installs of the application 202 per time unit which are traced to direct exposure of users such as the users 204 to content published as part of the application distribution activity, and numbers of consequent installs per each time unit which consequently follow direct installs. Each of the install types is marked in graph chart 302 with a respective grey scale shade as detailed in the index of the graph chart 302.

The numbers associated with the installs may be determined and/or computed, for example, by an install tracker such as the install tracker 220 as described in process 100. As seen in the graph chart, the numbers associated with the direct installs, the consequent installs, and the unrelated installs summed together add up to the number associated with the total installs.

For example, the numbers associated with the total installs and/or the direct installs may be determined by the install tracker 220, as described in steps 104 and 106 of the process 100, based on install reports received from one or more systems, such as, for example, the application vendor system 240, the application distribution system 230, and/or the like. These reports may indicate the numbers associated with the total installs and/or the direct installs in general, and further per time unit, for example, per each day of days N through N+7 of the application distribution activity.

In another example, the install tracker 220 may drive an unrelated install level reflecting the number of the unrelated installs as described in step 108 of the process 100. For example, the install tracker 220 may determine the total number of installs at one or more time units while the application distribution activity is not active, for example, prior to launch of the application distribution activity, for example, days N−2 and N−1. Based on the total number of all installs while the application distribution activity is not active, the install tracker 220 may determine the unrelated install level, for example, by averaging the number of all installs in each of days N−2 and N−1. The install tracker 220 may then apply the averaged unrelated install level for the duration of the application distribution activity, i.e., for days N through N+7.

Based on the number of total installs per time unit (day), the number of direct installs per time unit (day) and the unrelated install level, the install tracker 220 may compute the number of consequent installs, specifically the number of consequent installs per time unit (day) as described in step 110 of the process 100, for example, by subtracting the numbers associated with the direct installs and unrelated installs from the number associated with the total installs.

As shown at graph chart 306, the install tracker 220 may determine, derive, and/or compute respective temporal patterns for the total installs, the direct installs, and the consequent installs, for example, by transforming the histograms of graph chart 304 into respective temporal patterns illustrated in graph chart 306.

As described herein before with relation to the process 100, the temporal patterns seen in graph chart 306, for example, the total installs temporal pattern, the direct installs temporal pattern, and the consequent installs temporal pattern may be reflect and/or indicate one or more trends, phenomenon, relations, and/or correlations between the installs and the exposure temporal pattern and/or among the various installs themselves.

According to some embodiments described herein, the install tracker 220 may track installs of the application 202 while a plurality of application distribution activities are launched and/or active simultaneously, i.e., the two application distribution activities are active in parallel.

For example, assuming another (second) application distribution activity at least partially overlaps the previously described (first) application distribution activity, for example, the two application distribution activities are launched at the same time, the second application distribution activity is launched before the first application distribution activity ends and/or vice versa, and/or the like. In such case, the install tracker 220 may execute the process 100 for the second application distribution activity.

As such, the certain time period described in the process 100 may be extended to define the time period during which at least one of the two application distribution activities is active.

The install tracker 220 may receive a second exposure temporal pattern reflecting exposure of the another (second) application distribution activity launched simultaneously with the first application distribution activity over the certain time period to promote the application 202. This may be done as described in step 102 of the process 100 for the exposure temporal pattern relating to the first application distribution activity.

The install tracker 220 may determine and/or compute a second total installs temporal pattern reflecting all installs of the application over the certain time period as described in step 104 of the process 100. The second total installs temporal pattern may reflect all installs over the certain time period which may be attributed to the first application distribution activity, the second application distribution activity and/or both.

The install tracker 220 may determine and/or compute a second direct installs temporal pattern reflecting a number associated with direct installs of the application 202 directly resulting from the second application distribution activity over the certain time period. This may be done as described in step 106 of the process 100 for the number associated with the direct installs of the application 202 directly resulting from the first application distribution activity.

The unrelated installs level determined and/or computed as described in step 108 of the process 100 may be unaffected by neither of the first and second application distribution activities.

The install tracker 220 may determine and/or compute a second consequent installs temporal pattern reflecting a number associated with consequent installs of the at application 202 which consequently follow-up on the direct installs relating to the second application distribution activity over the certain time period. In particular, the install tracker 220 may determine and/or compute a second consequent installs temporal pattern based on the second total installs temporal pattern, the second direct installs temporal pattern, and the unrelated installs level as described in step 110 of the process 100 for the number associated with the consequent installs of the application 202 relating to the first application distribution activity.

The install tracker 220 may apply one or more methods, techniques, and/or algorithms for distinguishing between direct and consequent installs attributed and/or relating to the first application distribution activity and those attributed and/or relating to second application distribution activity.

For example, the install tracker 220 may analyze the distribution of total, direct, and consequent installs over the certain time period with respect to the first and second exposure temporal patterns to identify a correlation between the installs and the each of the two application distribution activities.

In another example, the exposure temporal pattern relating to the first application distribution activity and the second exposure temporal pattern may be orthogonal to each other. Orthogonality in general may relate to relation between two or more functions over a certain interval such that the integral of the product of a pair of functions over the certain interval is zero. In the instant case, the orthogonality between the first and second exposure temporal patterns indicates that the first application distribution activity and the second application distribution activity are not related to each or weakly related at worst.

This orthogonality may be expressed by publishing the content relating to each of the two application distribution activities according to different timing, different schedule, at different geographical locations, and/or the like, and/or a combination thereof. For example, the first application distribution activity may define publishing content according to a first schedule while the second application distribution activity may define publishing content according to a second schedule which is very different and does not overlap with the first schedule. In another example, the first application distribution activity may define publishing content at a first geographical area while the second application distribution activity may define publishing at a second geographical area different from the first geographical area. As such, the install tracker 220 may accurately identify and distinguish between direct installs attributed to each of the two application distribution activities. The install tracker 220 may therefore trace consequent installs to the direct installs on which the consequent installs follow-up and thus compute an increased accuracy consequent installs temporal pattern for each of the two application distribution activities, i.e., a first consequent installs temporal pattern for the first application distribution activity, and a second consequent installs temporal pattern for the second application distribution activity.

In another example, the install tracker 220 may analyze the distribution of total, direct, and consequent installs during one or more time units in which only one of the two application distribution activities is active to identify one or more install patterns associated with the currently active application distribution activity.

The install tracker 220 may transmit the second consequent installs temporal pattern to one or more systems, for example, the distribution system(s) 230, the application vendor system(s) 240, the promotion system(s) 250, and/or the like as describe as described in step 112 of the process 100. These systems may be adapted to adjust one or more application distribution activities according to the increased accuracy second consequent installs temporal pattern, optionally in conjunctions with the consequent installs temporal pattern computed with relation to the first application distribution activity.

According to some embodiments there are provided methods and systems for determining an outcome of an application distribution activities, for example, a marketing campaign directed to increasing an install base of a certain application.

An install tracker such as the install tracker 220 executed by a tracking system such as the install tracking system 200 may determine a change, over time, in an intensity associated with a marketing campaign relating to the certain application. The change may be characterized by a specific time-varying pattern.

The install tracker 220 may receive, via a first interface, for example, the network interface 210, a report describing, over time, a number associated with a number of paid installs (direct installs) of the certain application. The paid installs, over time, are a direct result of the intensity of the marketing campaign changing over time.

The install tracker 220 may observe, over time, a change in a number associated with a total install base of the certain application.

The install tracker 220 may calculate, using the specific time-varying pattern, a number associated with a number of viral organic installs (consequent installs) over time. The number associated with the number of viral organic installs is a consequent follow-up of the paid installs.

As such, after subtracting the calculated number associated with the viral organic installs and the number associated with the paid installs from the number associated with the total install base, there is substantially no remaining signature of the specific time-varying pattern.

The install tracker 220 may make available at least the calculated number associated with the viral organic installs, and/or a parameter related to the calculated number associated with of the viral organic installs, to an entity associated with the marketing campaign, thereby causing one or more effects on the marketing campaign.

The numbers associated with the number of paid installs, total install base and/or viral organic installs may be expressed using one or more metrics, methods, and/or representations.

For example, the number associated with the number of paid installs may be the actual number of paid installs, the number associated with the total install base may be an actual number representing the total install base, and/or the number associated with the number of viral organic installs may be the actual number of viral organic installs.

In another example, the number associated with the number of paid installs may be a revenue associated with the number of paid installs, the number associated with the total install base may be a revenue associated with the total install base, and/or the number associated with the number of viral organic installs may be a revenue associated with the number of viral organic installs.

Determining the change over time by the install tracker 220 may comprises, for example, observing and recording, after the marketing campaign is initiated, the specific time-varying pattern as an emerging characteristic associated with the marketing campaign. In another example, determining the change over time by the install tracker 220 may comprise purposely selecting the specific time-varying pattern from several possible different time-varying patterns, in which the selection is made prior to initiation of the marketing campaign.

Optionally, the marketing campaign may constitute a first marketing campaign executed constitute a concurrently a with a second marketing campaign.

An intensity associated with the first marketing campaign may be characterized by a first time-varying pattern. In such case, the install tracker 220 may purposely select a second change, over time, in an intensity associated with the second marketing campaign associated with the same certain application. The second change is characterized by a second time-varying pattern that is substantially orthogonal, over time, to the first time-varying pattern.

The install tracker 220 may calculate, using the second time-varying pattern, a second number associated with a second number of viral organic installs over time that is attributed to the second marketing campaign. The second number associated with the second number of viral organic installs is a consequent follow-up of the paid installs resulting from the second marketing campaign. The second number associated with the second number of viral organic installs attributed to the second marketing campaign, is substantially independent and unaffected by the number associated with the number of viral organic installs attributed to the first marketing campaign, as a direct result of said second time-varying pattern being substantially orthogonal, over time, to said first time-varying pattern.

One or more of the effects on the marketing campaign may comprise reaching a decision that the first marketing campaigns is yielding a better (increased) number associated with the viral organic installs than the second marketing campaign. Accordingly the first marketing campaign may be expanded, in which the expansion may comprise at least increasing the intensity of the first marketing campaign.

The intensity, of the marketing campaign, may be related to expenditure associated with the marketing campaign. As such, increasing the expenditure may correspond to increasing the intensity, and decreasing the expenditure may correspond to decreasing the intensity.

The specific time-varying pattern is a specific sequence-in-time of different levels of expenditure in the marketing campaign.

The period between a beginning of one of the levels to a beginning of a following level in the sequence-in-time may be between 1 (one) day and 1 (one) week.

The sequence-in-time may comprise at least 10 (ten) different levels, thereby facilitating orthogonality with another sequence-in-time associated with a different marketing campaign associated with the same certain application. The marketing campaign therefore lasts for at least 10 (ten) days.

According to some embodiments, the certain application may be a game. In such embodiments, the number associated with the total install base may be associated with gamers (users) installing the game on their gaming devices, for example, a personal computer, a Smartphone, a tablet, a gaming console, and/or the like.

The number associated with the number of paid installs may be associated with gamers installing the game from an application store after being exposed to an advertisement in conjunction with the marketing campaign, and after directed to the application store as a result of clicking/responding to the advertisement. The report may be received from the application store.

The number associated with the total install base may be observed by considering all installs of the game as reported by all installed instances of the certain application communicating with the entity.

The number associated with the viral organic installs may be associated with installs that happen (occur, take place) when gamers, who obtained the certain application in conjunction with the paid installs, influence other gamers to install the game.

According to some embodiments, the certain application is a mobile application. In such embodiments, the number associated with the total install base may be associated with installing the mobile application on devices such as, for example, a laptop, a Smartphone, a tablet, and/or the like.

As stated herein before, the intensity of the marketing campaign, may be related to expenditure associated with the marketing campaign. Therefore, increasing the expenditure may correspond to increasing said intensity, and decreasing the expenditure may correspond to decreasing said intensity. The specific time-varying pattern may be a specific sequence-in-time of different levels of expenditure in the marketing campaign.

The different levels of expenditure may be determined, for example, using a random and/or a pseudo random sequence, thereby facilitating orthogonality with another sequence-in-time associated with a different marketing campaign associated with the same certain application.

In another example, the specific time-varying pattern may be associated with a sinusoidal pattern having a specific frequency, thereby facilitating orthogonality with another sinusoidal pattern having a specific different frequency and related to a different marketing campaign associated with the same certain application.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems, methods and computer programs will be developed and the scope of the terms application, and application distribution activity are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method of improving detection of installation types of applications, comprising:
using an install evaluation system adapted for:
receiving an exposure temporal pattern reflecting exposure of at least one application distribution activity launched over a certain time period to promote installation of at least one application;
determining a total installs temporal pattern reflecting a total number associated with all installs of the at least one application over the certain time period;
determining a direct installs temporal pattern reflecting a number associated with direct installs of the at least one application resulting from direct exposure to the at least one application distribution activity over the certain time period;
deriving an unrelated installs level reflecting a number associated with installs of the at least one application which are unrelated to the at least one application distribution activity;
computing, based on the total installs temporal pattern, the direct installs temporal pattern, and the unrelated installs level, a consequent installs temporal pattern reflecting with increased accuracy a number associated with consequent installs of the at least one application which consequently follow-up on the direct installs over the certain time period; and
transmitting the consequent installs temporal pattern to at least one distribution system adapted to adjust at least one application distribution activity according to the increased accuracy consequent installs temporal pattern.

2. The method of claim 1, wherein the number associated with direct installs is determined based on a number associated with direct installs of the at least one application as result of respective users exposed to content published as part of the at least one application distribution activity.

3. The method of claim 1, wherein the total number associated with all installs is determined based on all installs reported by a vendor of the at least one application.

4. The method of claim 1, wherein the unrelated installs level expresses an averaged level of installs of the at least one application over the certain time period which are independent of the exposure temporal pattern.

5. The method of claim 1, wherein the number associated with consequent installs expresses a number associated with installs of the at least one application by users influenced by other users who made the direct installs.

6. The method of claim 1, wherein the exposure of at least one application distribution activity relates to expenditure invested in the at least one application distribution activity.

7. The method of claim 6, wherein the exposure temporal pattern reflects a plurality of expenditure levels over the certain time period.

8. The method of claim 7, wherein the plurality of expenditure levels are selected according to a random and/or pseudo-random pattern.

9. The method of claim 7, wherein the plurality of expenditure levels are selected according to sinusoidal pattern having a certain frequency.

10. The method of claim 7, wherein a time period of each expenditure level is selected from a range of one day to one week.

11. The method of claim 7, wherein a number of the expenditure levels is selected from a range of five to fifteen.

12. The method of claim 1, wherein the exposure temporal pattern is selected from a plurality of exposure temporal patterns according to at least one parameter of the at least one application distribution activity.

13. The method of claim 1, wherein the install evaluation system is further adapted for:
receiving a second exposure temporal pattern reflecting exposure of at least one another application distribution activity launched simultaneously with the at least one application distribution activity over the certain time period to promote the at least one application;
determining a second total installs temporal pattern reflecting a total number associated with all installs of the at least one application over the certain time period;
determining a second direct installs temporal pattern reflecting a number associated with direct installs of the at least one application directly resulting from the at least one another application distribution activity over the certain time period;
computing, based on the second total installs temporal pattern, the second direct installs temporal pattern and the unrelated installs level, a second consequent installs temporal pattern reflecting a number associated with consequent installs of the at least one application which consequently follow-up on the direct installs relating to the at least one another application distribution activity over the certain time period; and
transmitting the second consequent installs temporal pattern to the at least one distribution system adapted to adjust at least one another application distribution activity according to the increased accuracy second consequent installs temporal pattern.

14. The method of claim 13, wherein the exposure temporal pattern and the second exposure temporal pattern are orthogonal to each other.

15. The method of claim 1, wherein the direct installs temporal pattern is computed based on an actual number of the direct installs, the total installs temporal pattern is computed based on an actual number of the total installs, and the consequent installs temporal pattern is computed based on an actual number of the consequent installs.

16. The method of claim 1, wherein the direct installs temporal pattern is computed based on a revenue associated with the direct installs, the total installs temporal pattern is computed based on a revenue associated with the total installs, and the consequent installs temporal pattern is computed based on a revenue associated with the consequent installs.

17. The method of claim 1, wherein each of the installs relates to installation of the at least one application in a client device used by a respective user.

18. The method of claim 1, wherein the at least one application is a member of a group comprising a game, and a mobile application.

19. A system for improving detection of installation types of applications, comprising:
an install evaluation system adapted to execute a code, the code comprising:
program instructions to receive an exposure temporal pattern reflecting exposure of at least one application distribution activity launched over a certain time period to promote installation of at least one application;
program instructions to determine a total installs temporal pattern reflecting a total number associated with all installs of the at least one application over the certain time period;
program instructions to determine a direct installs temporal pattern reflecting a number associated with direct installs of the at least one application resulting from direct exposure to the at least one application distribution activity over the certain time period;
program instructions to derive an unrelated installs level reflecting a number associated with installs of the at least one application which are unrelated to the at least one application distribution activity;
program instructions to compute, based on the total installs temporal pattern, the direct installs temporal pattern and the unrelated installs level, a consequent installs temporal pattern reflecting with increased accuracy a number associated with consequent installs of the at least one application which consequently follow-up on the direct installs over the certain time period; and
program instructions to transmit the consequent installs temporal pattern to at least one distribution system adapted to adjust at least one application distribution activity according to the increased accuracy consequent installs temporal pattern.

20. A computer program product of improving detection of installation types of applications, comprising a non-transitory medium storing thereon computer program instructions which, when executed by at least one hardware processor, cause the at least one hardware processor to:
receive an exposure temporal pattern reflecting exposure of at least one application distribution activity launched over a certain time period to promote installation of at least one application;
determine a total installs temporal pattern reflecting a total number associated with all installs of the at least one application over the certain time period;
determine a direct installs temporal pattern reflecting a number of direct installs associated with the at least one application resulting from direct exposure to the at least one application distribution activity over the certain time period;
derive an unrelated installs level reflecting a number associated with installs of the at least one application which are unrelated to the at least one application distribution activity;
compute, based on the total installs temporal pattern, the direct installs temporal pattern and the unrelated installs level, a consequent installs temporal pattern reflecting with increased accuracy a number associated with consequent installs of the at least one application which consequently follow-up on the direct installs over the certain time period; and
transmit the consequent installs temporal pattern to at least one distribution system adapted to adjust the at least one application distribution activity according to the increased accuracy consequent installs temporal pattern.
